(19) United States
(12) Patent Application Publication
(10) Pub. No.: US 2026/0233395 A1
(43) Pub. Date: Aug. 13, 2026

(54) ROBOT CONTROL DEVICE

(71) Applicant: FANUC CORPORATION, Minamitsuru-gun, Yamanashi (JP)

(72) Inventors: Shintaro NIIMURA, Minamitsuru-gun, Yamanashi (JP); Gou INABA, Minamitsuru-gun, Yamanashi (JP)

(73) Assignee: FANUC CORPORATION, Minamitsuru-gun, Yamanashi (JP)

(21) Appl. No.: 19/152,588

(22) PCT Filed: Feb. 8, 2023
(86) PCT No.: PCT/JP2023/004227

§ 371 Date: Jul. 31, 2025

(51) Int. Cl. B25J 9/16; B25J 13/06; B25J 13/08

(52) U.S. Cl. CPC B25J 9/1666; B25J 13/06; B25J 13/08

(57) ABSTRACT

This robot control device comprises an operation control unit that controls an operation of a robot. The control device is provided with a storage unit that stores a physical characteristic of an operator, and a region-setting unit that, according to the physical characteristic, sets a specific region which limits the operation of the robot.

### TECHNICAL FIELD

The present disclosure relates to a robot controller.

### BACKGROUND ART

In the prior art, a robot apparatus in which an operator performs work in cooperation with a robot is known. In a robot apparatus that performs work in cooperation with an operator, the robot and the operator can perform work without providing a safety fence for separating the robot and the operator around the robot. For example, a robot apparatus in which the robot apparatus and an operator convey a workpiece in cooperation with each other is known.

In a robot apparatus that performs work in cooperation with an operator, control is known in which a robot changes a position and an orientation according to a height or a posture of the operator so that the operator can easily perform work. For example, when the robot conveys a workpiece together with the operator, the operator can easily perform the work by changing a height at which the workpiece is conveyed according to the height of the operator. As a result, work efficiency of the operator is improved.

### CITATION LIST

### Patent Literature

PTL 1: International Publication No. WO 2017/203937A1
PTL 2: Japanese Unexamined Patent Publication No. 2019-98455A
PTL 3: International Publication No. WO 2022/039115A1

### SUMMARY OF INVENTION

### Technical Problem

In a robot apparatus that performs work in cooperation with an operator, a robot may come into contact with the operator. The robot apparatus can be configured to stop the robot when the operator comes into contact with it. For example, when an external force acting on the robot is detected, a robot controller can ensure the safety of the operator by stopping the robot.

However, it may be preferable that the robot does not come into contact with a specific part of the operator. To meet this request, an operation program of the robot can be prepared so that the robot does not reach a specific part of one operator. However, the physical features such as the physique of the operator vary according to the operator. Thus, if the operator who works cooperatively with the robot apparatus is changed, the robot may reach a different body part of the changed operator. Moreover, even if the operation program is prepared by setting teaching points in consideration of the physique or the like of the operator, a movement path between the teaching points is not known until the robot is actually moved. Therefore, there is no guarantee that the robot will not come into contact with the part of the operator. In this way, the robot is desired to be controlled so that it does not come into contact with a specific part of the operator.

### Solution to Problem

A robot controller according to an aspect of the present disclosure includes an operation control unit configured to control an operation of a robot, a storage configured to store a physical feature of an operator, and a region setting unit configured to set a specific region where the operation of the robot is limited based on the physical feature.

### BRIEF DESCRIPTION OF DRAWINGS

FIG. 1 is a schematic view of a robot apparatus in a first embodiment.

FIG. 2 is a block diagram of the robot apparatus including a controller in the first embodiment.

FIG. 3 is a block diagram of a region setting unit included in a processing unit of the controller.

FIG. 4 is a perspective view of a body region, a work region, and a specific region set in the first embodiment.

FIG. 5 is a main image for controlling an operation of the robot apparatus with respect to a contact of the robot apparatus in the first embodiment.

FIG. 6 is a main image for explaining an operation for setting a work region.

FIG. 7 is an image for selecting a method of acquiring the height of an operator.

FIG. 8 is an image for operating data relating to the height of the operator.

FIG. 9 is an image for inputting a password for operating the height of the operator.

FIG. 10 is an image when the height of the operator is detected by manually driving the robot apparatus.

FIG. 11 is a schematic perspective view of the robot apparatus when the robot apparatus is manually driven.

FIG. 12 is an image for selecting a model of the robot apparatus in the first embodiment.

FIG. 13 is an image for setting the height of a body of the main image for controlling the operation of the robot apparatus in the first embodiment.

FIG. 14 is a block diagram of a processing unit of a controller in a second embodiment.

FIG. 15 is a block diagram of a program operation unit in the second embodiment.

FIG. 16 is a main image for controlling the operation of a robot apparatus with respect to a contact of the robot apparatus in the second embodiment.

FIG. 17 is a main image after the robot apparatus is simulated.

FIG. 18 is a schematic side view of the robot apparatus for explaining correction of an operation program.

FIG. 19 is a perspective view of a body region, a work region, and a specific region set in a third embodiment.

FIG. 20 is a main image for controlling an operation of a robot apparatus with respect to a contact of the robot apparatus in the third embodiment.

FIG. 21 is an image for selecting a method of acquiring the height of the part of an operator.

FIG. 22 is another image for setting the height of a body part of the main image for controlling the operation of the robot apparatus in the third embodiment.

### DESCRIPTION OF EMBODIMENTS

### First Embodiment

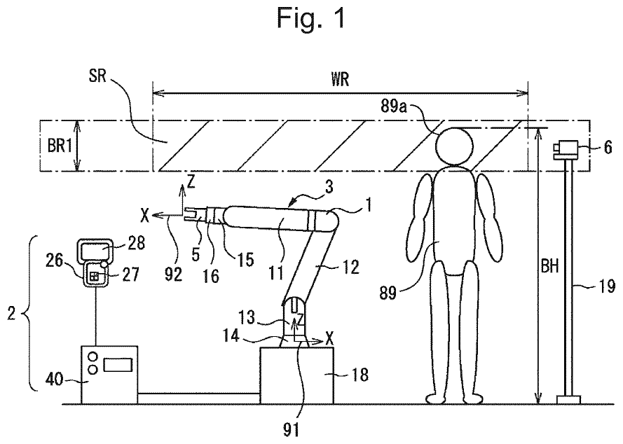

A robot controller according to a first embodiment is described with reference to FIGS. 1 to 12. A robot apparatus of the present embodiment includes a robot including a plurality of constituent members, a work tool attached to the robot, and the robot controller for controlling the robot and the work tool.

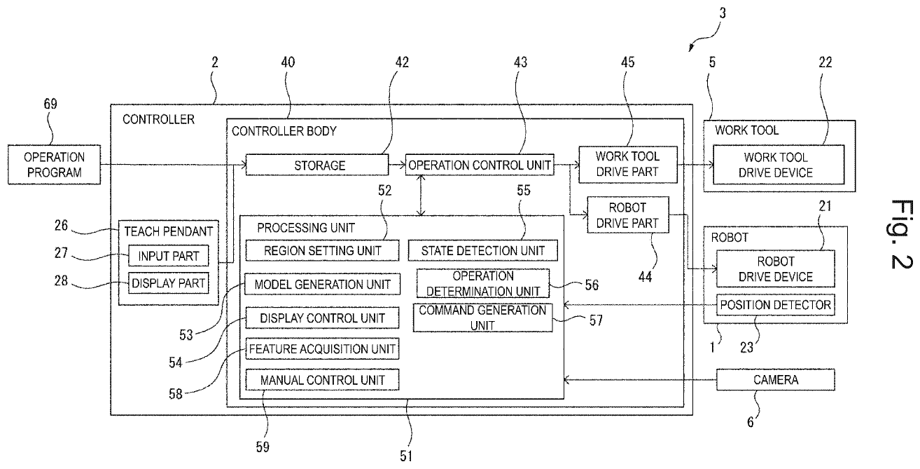

FIG. 1 is a schematic view of the robot apparatus in the present embodiment. FIG. 2 is a block diagram of the robot apparatus in the present embodiment. Referring to FIGS. 1 and 2, a robot apparatus 3 includes a work tool 5 that performs predetermined work and a robot 1 that moves the work tool 5. The robot apparatus 3 includes a controller 2 that controls the robot apparatus 3. The work tool 5 of the present embodiment is a hand that grips and releases a workpiece. The work tool 5 is not limited to a hand, and any device can be employed according to work performed by the robot apparatus 3. For example, a welding torch that performs arc welding or a laser welder that performs laser welding can be employed as the work tool.

The robot 1 of the present embodiment is an articulated robot including a plurality of joints. The robot 1 includes a base 14 fixed to an upper surface of a frame 18 as an installation surface and a swivel base 13 rotatably supported by the base 14. The robot 1 includes an upper arm 11 and a lower arm 12. The lower arm 12 is rotatably supported by the swivel base 13. The upper arm 11 is rotatably supported by the lower arm 12. Moreover, the upper arm 11 rotates around a drive axis parallel to an extending direction of the upper arm 11. The robot 1 includes a wrist 15 rotatably supported by the upper arm 11. The wrist 15 includes a flange 16 that is rotatably formed. The work tool 5 is fixed to the flange 16. In this way, the robot 1 of the present embodiment includes a plurality of constituent members. The plurality of constituent members is mutually coupled via joints.

The robot of the present embodiment is constituted by a collaborative robot that performs work in cooperation with an operator. A robot apparatus including the collaborative robot can have a function of limiting the operation of the robot when the operator comes into contact with the robot. For example, the collaborative robot can include a force sensor that detects an external force acting on the robot. The controller detects the external force acting on the robot, based on the output of the force sensor. The controller has a function of stopping the robot or evacuating the robot when the external force exceeds a limit value. The robot is not limited to this configuration, and any robot that can change the position and orientation of the work tool can be employed.

The robot 1 of the present embodiment includes a robot drive device 21 including drive motors for driving the constituent members such as the upper arm 11. The work tool 5 includes a work tool drive device 22 including a drive motor, a cylinder, or the like for driving the work tool 5.

The controller 2 of the robot includes a controller body 40 and a teach pendant 26 through which the operator operates the controller body 40. The controller body 40 includes an arithmetic processing device (computer) including a central processing unit (CPU) as a processor. The arithmetic processing device includes a random access memory (RAM), a read only memory (ROM), and the like connected to the CPU via a bus. The robot 1 and the work tool 5 are driven based on operation commands of the controller 2. The robot apparatus 3 automatically performs work based on an operation program 69.

The controller body 40 includes a storage 42 that stores any information regarding the robot apparatus 3. The storage 42 can be constituted by a non-transitory storage medium capable of storing information. For example, the storage 42 can be constituted by a storage medium such as a volatile memory, a nonvolatile memory, a magnetic storage medium, or an optical storage medium. The operation program 69 prepared in advance for performing the operation of the robot 1 is stored in the storage 42.

The controller body 40 includes an operation control unit 43 that controls the operations of the robot 1 and the work tool 5. The operation control unit 43 transmits an operation command for driving the robot 1 based on the operation program 69 to a robot drive part 44. The robot drive part 44 includes an electric circuit that drives a drive motor and supplies electricity to the robot drive device 21 based on the operation command. The operation control unit 43 also transmits, to a work tool drive part 45, an operation command for driving the work tool drive device 22. The work tool drive part 45 includes an electrical circuit that drives a motor or the like and supplies electricity or the like to the work tool drive device 22, based on the operation command.

The operation control unit 43 corresponds to a processor that is driven in accordance with commands written in the operation program 69 and other commands. The processor is formed to be able to read information stored in the storage 42. The processor serves as the operation control unit 43 by reading the operation program 69 and performing control defined in the operation program 69.

The robot 1 includes a state detector for detecting the position and orientation of the robot 1. The state detector in the present embodiment includes a position detector 23 attached to the drive motor of each drive axis of the robot drive device 21. The position detector 23 can be constituted by, for example, an encoder that detects the rotational position of an output shaft of the drive motor. The position and the orientation of the robot 1 are detected from the output of each position detector 23.

A reference coordinate system 91 that does not move when the position and the orientation of the robot 1 are changed is set for the robot apparatus 3. In the example illustrated in FIG. 1, the origin of the reference coordinate system 91 is arranged at the base 14 of the robot 1. The reference coordinate system 91 is also called a world coordinate system. In the reference coordinate system 91, the position of the origin is fixed, and the directions of the coordinate axes are further fixed.

A tool coordinate system 92 having an origin set at an arbitrary position of the work tool 5 is set for the robot apparatus 3. The position and the orientation of the tool coordinate system 92 are changed together with the work tool 5. In the present embodiment, the origin of the tool coordinate system 92 is set at a tool center point of the work tool 5. The position of the robot 1 corresponds to the position of the origin of the tool coordinate system 91 in the reference coordinate system 91. The orientation of the robot 1 corresponds to the orientation of the tool coordinate system 92 with respect to the reference coordinate system 91.

The teach pendant 26 is connected to the controller body 40 via a communication device. The teach pendant 26 includes an input part 27 for inputting information regarding the robot apparatus 3. The input part 27 is constituted by input members such as a keyboard, buttons, and dials. The teach pendant 26 includes a display part 28 that displays the information regarding the robot apparatus 3. The display part 28 can be constituted by a display panel capable of displaying information of a liquid crystal display panel, an organic electro luminescence (EL) display panel, or the like. The information displayed on the display part 28 is operated by operating the input part 27. When the teach pendant 26 includes a display panel of touch panel type, the display panel serves as an input part and a display part.

The robot apparatus 3 of the present embodiment includes a camera 6 as a sensor for acquiring physical features of the operator. The camera 6 of the present embodiment is a camera that acquires a two-dimensional image. The camera 6 is supported by a support member 19 and the position and orientation of the camera 6 are fixed.

The controller body 40 in the present embodiment includes a processing unit 51 that performs control for limiting the operation of the robot 1, based on the physical feature of the operator. The processing unit 51 includes a region setting unit 52 that sets a specific region where the operation of the robot is limited based on the physical features of the operator. The physical features of the operator are stored in the storage 42.

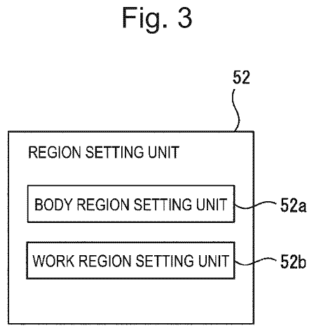

FIG. 3 illustrates a block diagram of the region setting unit in the present embodiment. The region setting unit 52 includes a body region setting unit 52a that sets a body region corresponding to the physical features of the operator. The region setting unit 52 further includes a work region setting unit 52b that sets a work region around the robot 1 in which an operator 89 performs work.

The physical feature of the operator indicates a feature related to the body of the operator who performs work in cooperation with the robot 1. The physical feature of the operator includes a height of a predetermined portion of the body of the operator. For example, the physical features include a height of the operator, a height of a face, a height of a chest, a height of an abdomen, a height of an upper leg being a portion of a leg above a knee, a height of a lower leg being a portion of a leg below a knee, and the like. The physical feature is not limited to the height of the predetermined portion of the body, but may be the position of a boundary between the right half part of the body and the left half part of the body. In other words, the physical feature may be a position of a boundary surface extending in the vertical direction. Moreover, the physical feature may include the size of each body part.

Referring to FIG. 2, the processing unit 51 includes a state detection unit 55 that detects a state of the robot. The state detection unit 55 can detect the position and the orientation of the robot 1. For example, the state detection unit 55 detects the position and the orientation of the robot 1 based on the output of the position detector 23. Alternatively, the state detection unit 55 may detect the position and the orientation of the robot 1 based on the operation command output by the operation control unit 43. In addition, the state detection unit 55 can detect the movement speed of a predetermined portion of the robot 1 based on the position and the orientation of the robot 1.

The processing unit 51 includes a model generation unit 53 that generates a three-dimensional model of the robot apparatus 3. The model generation unit 53 generates the three-dimensional model of the robot apparatus 3 including a model of the robot 1 and a model of the work tool 5, based on the three-dimensional shape data of the constituent members of the robot apparatus 3 stored in the storage 42. Shape data output from a computer aided design (CAD) device, for example, can be used as the three-dimensional shape data. The three-dimensional shape data is stored in the storage 42.

Alternatively, the three-dimensional model of the robot apparatus 3 may be generated in advance and stored in the storage 42. For example, the model of the work tool can generate a simple three-dimensional model by combining models such as a sphere, a hemisphere, a cylinder, and a rectangular parallelepiped. The simple model can be formed larger so that an actual work tool is included within the model. Alternatively, a simple model in which geometric shapes are combined may be generated for the robot. Such a simple model can be generated by operating the teach pendant.

The processing unit 51 includes an operation determination unit 56 that determines whether or not a predetermined portion of the robot apparatus 3 has entered a specific region during a period in which the robot 1 is driven. The operation determination unit 56 of the present embodiment determines whether or not the predetermined portion of the robot apparatus 3 has entered the specific region, based on the three-dimensional model of the robot apparatus.

The processing unit 51 includes a manual control unit 59 that generates a command for manually driving the robot 1 in response to an operation of the operator 89. The operation program 69 may include, in addition to a program for causing the robot apparatus 3 to automatically perform work, a program executed by the manual control unit 59, which is necessary for manually operating the robot apparatus 3 by the teach pendant 26. The operation command generated by the manual control unit 59 of the processing unit 51 is transmitted to the operation control unit 43. The operation control unit 43 drives the robot 1 based on the operation command. When the robot 1 is driven based on the operation command generated by the manual control unit 59, the operation control unit 43 may perform control for stopping the robot 1 in a state in which the robot 1 is about to come into contact with the head or the like of the operator.

The processing unit 51 includes a feature acquisition unit 58 that acquires physical features of the operator 89 who performs work in cooperation with the robot 1. The feature acquisition unit 58 of the processing unit 51 has a function of calculating a height as a physical feature, based on the position and the orientation of the robot 1. The processing unit 51 further includes a command generation unit 57 that generates a command for correcting the operation of the robot 1 corresponding to the determination of the operation determination unit 56. The processing unit 51 includes a display control unit 54 that controls an image displayed on the display part 28 of the teach pendant 26.

Each of the processing unit 51, the region setting unit 52, the model generation unit 53, the display control unit 54, the state detection unit 55, the operation determination unit 56, the command generation unit 57, the feature acquisition unit 58, and the manual control unit 59 corresponds to a processor that is driven in accordance with a predetermined program. Referring to FIG. 3, each of the body region setting unit 52a and the work region setting unit 52b corresponds to a processor that is driven in accordance with a predetermined program. The processor serves as each of the units by reading the program stored in the storage 42 and performing control defined in the read program.

In the controller 2 of the present embodiment, the region setting unit 52 sets, as the specific region, a region where a head 89a of the operator 89 is likely to be present. Subsequently, the operation determination unit 56 determines whether or not at least one of the constituent members (e.g., the robot 1, the work tool 5 attached to the robot 1, and the workpiece) of the robot apparatus 3 has entered the specific region. When at least one of the constituent members of the robot apparatus 3 has entered the specific region, the command generation unit 57 performs control for stopping the robot 1.

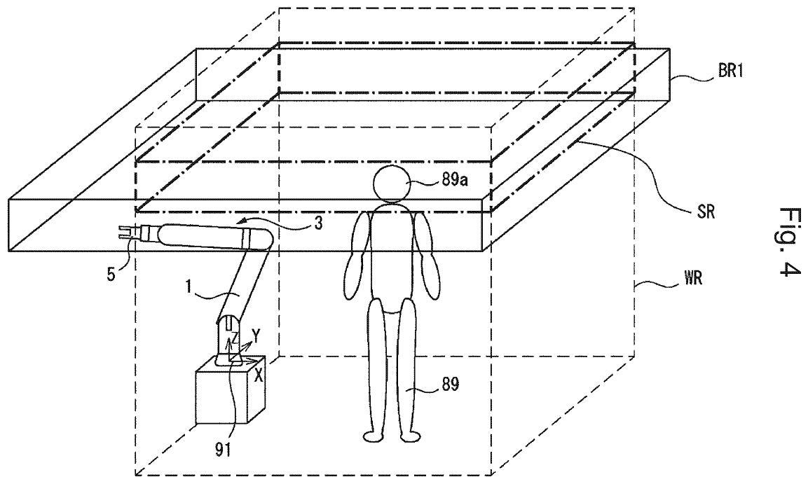

FIG. 4 is a schematic perspective view for explaining the body region, the work region, and the specific region set by the region setting unit of the present embodiment. Referring to FIGS. 1 to 4, based on the physical feature of the operator 89, the region setting unit 52 sets a specific region SR where the operation of the robot 1 is limited.

The upper end of the head 89a of the operator 89 corresponds to a height BH of the operator 89. In the controller 2 of the present embodiment, the physical feature of the operator 89 is the height BH of the operator 89. The region setting unit 52 sets the specific region SR corresponding to the height BH of the operator 89. The region setting unit 52 can set each region by using, for example, the coordinate values of the reference coordinate system 91 of the robot 1.

The body region setting unit 52a of the region setting unit 52 sets a body region BR1 being a region where the head 89a as a body part of the operator 89 is present. The body region setting unit 52a acquires the height BH of the operator 89. Based on the height BH of the operator, the body region setting unit 52a sets the body region BR1 to which the head 89a is considered to move.

Since the operator 89 walks around along a floor surface during work, it can be considered that the head 89a moves horizontally. Thus, the body region BR1 of the present embodiment is set in a rectangular parallelepiped shape so as to extend horizontally. In other words, the height of the body region BR1 is constant, and is set so as to extend in the X-axis direction and the Y-axis direction of the reference coordinate system 91. The body region setting unit 52a can set a height obtained by adding a predetermined margin to the height BH as the height of an upper surface of the body region BR1. In addition, the body region setting unit 52a can set a height obtained by subtracting a predetermined length of the head 89a from the height BH as the height of a lower surface of the body region BR1. The width of the body region BR1 can be set within a range of 20 cm to 30 cm, for example.

The body region BR1 can be set inside a predetermined space. In the present embodiment, the body region BR1 can be set within a movable range reached by the robot apparatus 3. The movable range reached by the robot apparatus 3 can be determined in advance and stored in the storage 42. The movable range reached by the robot apparatus 3 can be set by the coordinate values of the reference coordinate system 91.

The body region BR1 can be set to any shape and any size. For example, when the operator crouches or stands, the body region may include a region extending in the vertical direction so as to correspond to a region where the head moves. The body region BR1 can be set so as to always include the head of the operator when the operator moves. In addition, the body region BR1 may be set to a region equal to or higher than the height of the lower surface of the head so as to include a region above the head of the operator.

Subsequently, the work region setting unit 52b of the region setting unit 52 sets the work region WR. The work region WR is a region where each part of the operator 89 may be present when the operator 89 performs work. The work region setting unit 52b can set the work region WR in response to the operation of the teach pendant 26 by the operator. The work region WR of the present embodiment is formed in a rectangular parallelepiped shape, but the present disclosure is not limited to this configuration. A work region having any shape and any size can be set based on a region where the operator moves.

The work region setting unit 52b may be formed so as to set a plurality of work regions WR. For example, the controller 2 can be configured to set a plurality of work regions WR in response to an input by the operator. Subsequently, the work region setting unit 52b may set the plurality of work regions to be valid or invalid based on a signal or the like from an external device during a period in which the robot apparatus 3 actually performs work. Alternatively, the work region setting unit 52b may be configured to calculate an entire work region by selecting two or more work regions from the plurality of work regions and adding the selected regions.

For example, there is a case where the operator performs work while standing or crouching. The work region setting unit 52b can receive a signal indicating that the operator is standing from an external device and select a work region having a high upper surface position. In addition, the work region setting unit 52b can receive a signal indicating that the operator is crouching from the external device and select a work region whose upper surface position is lower than that of the above work region.

In addition, in the present embodiment, the body region is set based on the height from the floor surface, but the present disclosure is not limited to this configuration. The body region may be set at a position relative to the work region. For example, the body region setting unit can acquire the work region and set, as the body region, a region of a predetermined ratio (e.g., 20% or the like) on the upper side in the height direction of the work region. The predetermined ratio may be determined corresponding to the height of the operator. According to this body region setting method, when the work region is changed, the body region can be relatively set corresponding to the work region.

The region setting unit 52 sets a region where the body region BR1 and the work region WR overlap each other as the specific region SR. The control can limit a region where a predetermined part of the operator is present. The specific region SR becoming large can be avoided, and the calculation amount of the processing unit of the controller can be reduced. It should be noted that the region setting unit may set the body region as the specific region without setting any work region.

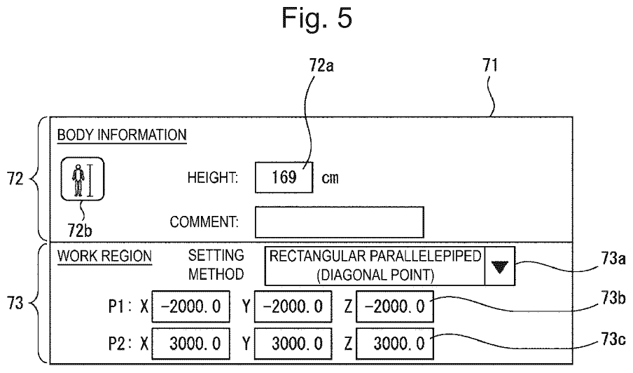

FIG. 5 illustrates an image displayed on the display part of the teach pendant in the present embodiment. An image 71 is a main image for controlling the operation of the robot apparatus 3 in relation to a contact between the operator 89 and the robot apparatus 3. In the image 71, the height of the operator can be set, or the work region can be set. A portion 72 of the image 71 is a portion to be operated when the height of the operator is set for setting the specific region. A portion 73 of the image 71 is a portion to be operated when the work region is set.

In the portion 72 of the image 71, a height as the physical feature of the operator can be manually set. The height of the operator is displayed in a text box 72a of the portion 72. The operator who works cooperatively with the robot apparatus 3 selects the text box 72a as an input region. By operating the input part 27 of the teach pendant 26, the height of the operator is input to the text box 72a. Subsequently, the body region setting unit 52a of the region setting unit 52 can set the body region BR1, based on the height of the operator.

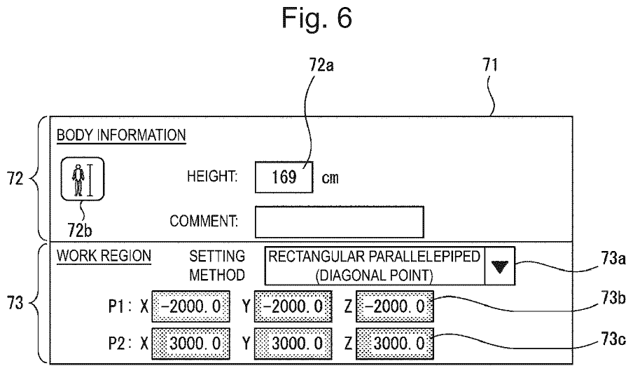

Subsequently, the operator who performs work with the robot apparatus 3 sets the work region. FIG. 6 illustrates a main screen when the work region is set. The operator sets the work region by operating a portion 73 of the image 71. Referring to FIG. 4, the work region WR in the present embodiment is a rectangular parallelepiped region. Referring to FIG. 6, the operator selects a method of setting the work region by operating a list box 73a of the portion 73. In this case, a rectangular parallelepiped work region is selected. The positions of two diagonal points P1 and P2 of the rectangular parallelepiped are displayed in text boxes 73b and 73c set by the coordinate values of the reference coordinate system 91.

The operator who works cooperatively with the robot apparatus manually inputs the coordinate values of the diagonal points P1 and P2 of the work region WR in the portion 73 of the image 71. By inputting, to the text boxes 73b and 73c, the coordinate value of the point P1 and the coordinate value of the point P2 that is arranged diagonally and opposite to the point P1, the work region setting unit 52b of the region setting unit 52 can set the work region WR. Alternatively, the coordinate values of the diagonal points P1 and P2 of the work region WR may be automatically set in response to the position of the robot 1 at the time point by operating the input part 27 of the teach pendant 26, for example.

In the present embodiment, a rectangular parallelepiped is selected as the work region, but the present disclosure is not limited to this configuration. The work region can be a region having a predetermined shape set by combining arbitrary three-dimensional shapes such as a rectangular parallelepiped, a cylinder, a sphere, and a polygonal pyramid. Moreover, the work region is set in the reference coordinate system, but the present disclosure is not limited to this configuration. The work region can be set in a predetermined arbitrary coordinate system. The work region setting unit 52b can set the work region WR based on a value input by the operator. Subsequently, the region setting unit 52 can set the specific region SR based on the body region BR1 and the work region WR. The coordinate values displayed in the text boxes 73b and 73c may also be based on any predetermined coordinate system. The values related to the height and the work region input by the operator may or may not be stored in the storage.

The controller 2 of the present embodiment performs control for stopping the robot apparatus 3 when at least a part of the constituent members of the robot apparatus 3 is determined to have entered the specific region SR during a period in which an actual work is performed by the robot apparatus 3.

During a period in which the robot apparatus 3 is driven in order to perform the actual work, the state detection unit 55 can detect the operation state of the robot 1. Subsequently, the model generation unit 53 generates a three-dimensional model corresponding to the current state of the robot apparatus 3. The model generation unit 53 can arrange the three-dimensional models of the robot 1 and the work tool 5 in a virtual space corresponding to the reference coordinate system 91, based on the position and the orientation of the robot 1 acquired by the state detection unit 55. The model generation unit 53 can also generate a three-dimensional model of the specific region SR.

The operation determination unit 56 determines whether or not at least a part of the constituent members included in the robot apparatus 3 has entered the specific region SR during a period in which the robot 1 is driven.

In particular, the operation determination unit 56 determines whether or not at least a part of the model of the robot 1 interferes with the model of the specific region SR. When at least a part of the model of the robot 1 interferes with the model of the specific region SR, it can be determined that the robot apparatus 3 has entered the specific region SR. Moreover, the operation determination unit 56 determines whether or not the model of the work tool 5 attached to the robot 1 interferes with the model of the specific region SR. In this way, when it is determined that at least one selected from a group of the model of the robot 1 and the model of the work tool 5 interferes with the specific region SR, it can be determined that at least a part of the robot apparatus 3 has entered the specific region SR.

When the operation determination unit 56 determines that at least a part of the robot apparatus 3 has entered the specific region SR, the command generation unit 57 transmits a command for stopping the robot 1 to the operation control unit 43. Upon receiving the command from the command generation unit 57, the operation control unit 43 performs control for stopping the robot 1. Alternatively, upon receiving the command from the command generation unit 57, the operation control unit 43 performs control for supplying no power to the motor being driven.

In this way, the controller 2 of the present embodiment sets the specific region SR where the head 89a of the operator 89 moves, and performs control for stopping the robot apparatus 3 when at least a part of the robot apparatus 3 has entered the specific region SR. After the robot apparatus 3 is stopped based on the determination of the operation determination unit 56, the operator who performs cooperative work can manually correct the operation program 69 of the robot apparatus 3.

By performing control for stopping the robot apparatus 3 based on the physical features of the operator 89 who performs actual work, the robot 1 or the work tool 5 coming into contact with a specific part such as the head 89a can be avoided. When the movement speed of the robot apparatus 3 is low, the robot may be allowed to come into contact with the thigh or the like of the body of the operator. However, the head of the operator is not a part of the body which is preferably allowed to be in contact with the robot or the work tool.

An operation program can be prepared so as to avoid a region where a specific part is present corresponding to one operator. However, since other operators have different heights, there is a problem that the height of the body part at which the robot is driven is unknown. In addition, it is difficult for the controller to distinguish this problem. On the contrary, the controller of the present embodiment, as described above, sets the specific region corresponding to the physical features of the operator who works cooperatively with the robot apparatus. In order to stop the robot apparatus when the robot apparatus has entered the specific region, the robot or the work tool coming into contact with a specific part of the operator can be avoided.

In the present embodiment, whether or not a predetermined portion of the model of the robot apparatus has entered the model of the specific region is determined, but the present disclosure is not limited to this configuration. The model generation unit may further prepare a model of a workpiece gripped by the work tool. Subsequently, the operation determination unit may determine whether or not the workpiece has entered the specific region. When the workpiece is determined to have entered the specific region, the command generation unit may perform control for stopping the robot apparatus.

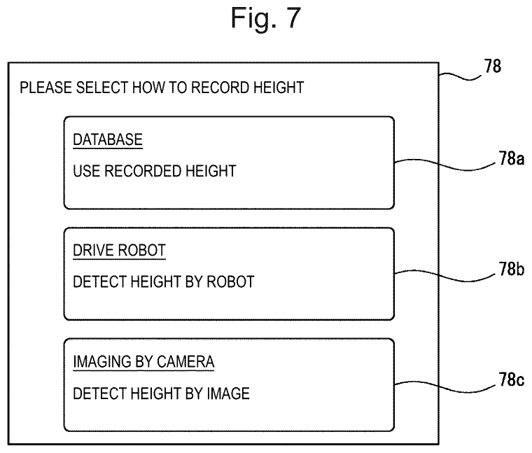

Referring to FIG. 5, in the portion 72 of the image 71, the physical feature of the operator can be manually set as the height, but the present disclosure is not limited to this configuration. Another operation of setting the height as the physical feature by the operator who works cooperatively with the robot apparatus 3 will be described hereafter. A button 72b for setting the height is displayed in the portion 72 of the image 71. FIG. 7 illustrates an image for setting the height of the operator. Referring to FIGS. 5 and 7, when the operator presses the button 72b, an image 78 is displayed on the display part 28. The image 78 includes buttons 78a, 78b, and 78c.

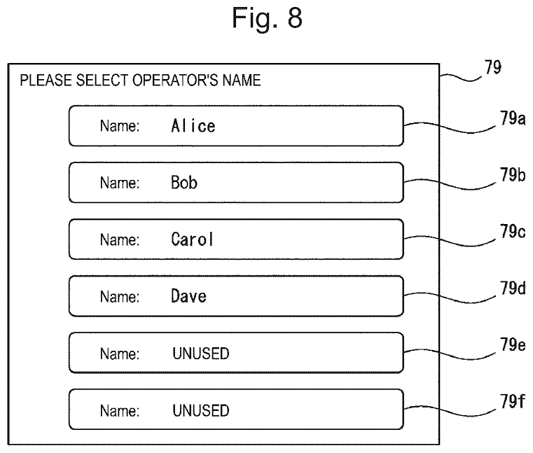

The button 78a is a button for recording the height of the operator or acquiring the current height of the operator from a plurality of heights already recorded. FIG. 8 illustrates an image displaying a database of heights of operators. An image 79 is an image displayed when the operator presses the button 78a illustrated in FIG. 7. Buttons 79a to 79f are displayed in the image 79. The name of the operator is displayed on each of the buttons 79a to 79d. Buttons 79e and 79f are buttons in which the height of the operator is not registered.

The names and heights of the operators displayed on the respective buttons 79a to 79f are stored in the storage 42. The operator can set the height by pressing a button with the operator's name. In other words, the height stored in the storage 42 can be displayed in the text box 72a of the portion 72 in FIG. 5. The operator can set the height by selecting the name even though the operator does not remember the height.

In the present embodiment, the operator may also be an operator who prepares a program. In this case, by setting the height of each operator in the portion 72 of the image 71 in FIG. 5 and executing the operation program, the operator who prepares the program can check whether or not the operation program can appropriately operate for the operator.

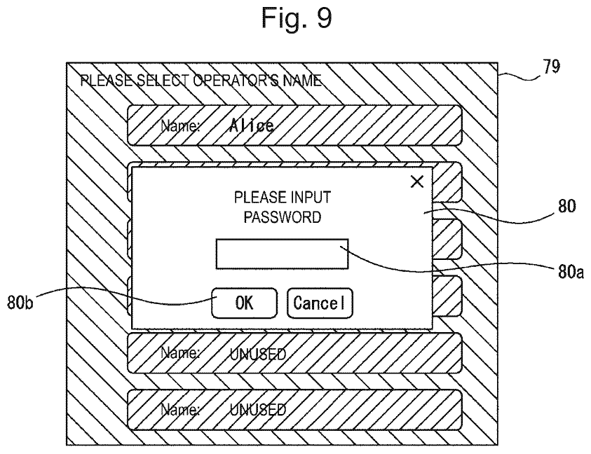

When the height of the operator stored in the storage 42 is changed, an operation of pressing any one of the buttons 79a to 79d with the names of the operators for a long time is performed. FIG. 9 illustrates an image displayed when the height of the operator is changed. Referring to FIGS. 8 and 9, by pressing a button with the operator's name for a long time, the display control unit 54 displays an image 80 so as to be superimposed on the image 79. The image 80 is a screen for inputting a password for registering or changing the height. For example, a password of an administrator of the controller can be employed. By inputting a password in the text box 80a and pressing the button 80b, the height of the operator can be changed and stored in the storage 42.

Similarly, even when newly setting a name and a height of an operator, for example, the operator presses the button 79e of the image 79 in FIG. 8 for a long time. When the operator inputs a password to the image 80 illustrated in FIG. 9, an image for inputting the name and height of the operator is displayed. The operator can input the name and height and store them in the storage 42. Alternatively, when the operator inputs a name, the height displayed in the text box 72a of the portion 72 in FIG. 5 may be stored. By this operation, the set name is displayed on the button 79e in FIG. 8.

In this way, when the operator operates the input part 27, the operator can be selected, or the height of the operator can be input. When the operator operates the input part 27, the storage 42 can store the height as the physical feature. The operator can easily set the height of the operator by selecting the name button. The body region setting unit 52a of the region setting unit 52 can set the body region BR1 based on the set height.

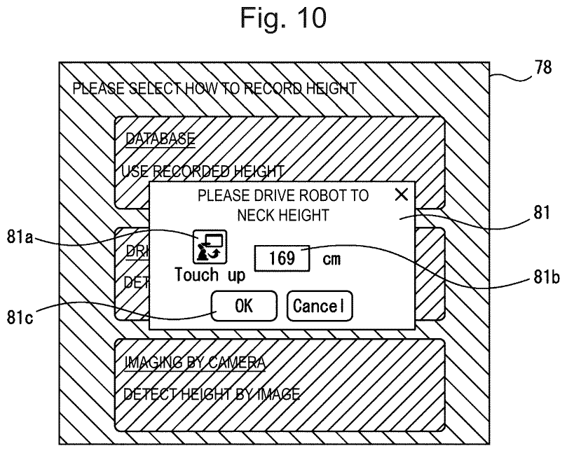

As another method of setting the height, the operator manually drives the robot 1 and sets the height of the operator, based on the position and the orientation of the robot 1. FIG. 10 illustrates an image in which the height of the operator is set by manually driving the robot. Referring to FIGS. 7 and 10, when the operator working cooperatively with the robot apparatus 3 presses the button 78b in the image 78, the display control unit 54 displays an image 81 so as to be superimposed on the image 78 as illustrated in FIG. 10. In the image 81, a button 81a for detecting the height of a tool center point of the robot apparatus 3 when the robot 1 is manually driven is arranged.

For example, the operation program 69 for setting the height of the operator when the upper arm 11, the lower arm 12, and the like of the robot 1 are driven may be provided. In this case, when the upper arm 11, the lower arm 12, and the like of the robot 1 move in the height direction and the work tool 5 reaches the vicinity of the operator's head, the operator operates a stop button of the image 81 or touches the robot 1 so as to stop the robot 1, and the height of the work tool 5 at the stop time point is recorded as the height of the operator.

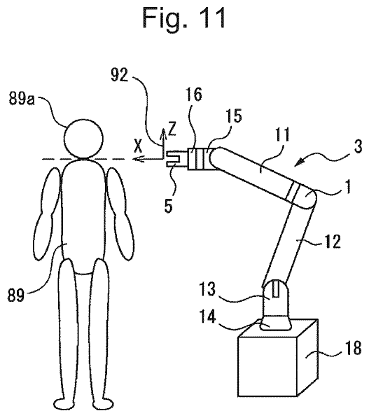

FIG. 11 illustrates a schematic perspective view of the robot apparatus when the operator is manually driving the robot. Referring to FIGS. 2 and 11, the manual control unit 59 can drive the robot 1 in response to the operation of the input part 27 of the teach pendant 26 by the operator. Alternatively, the controller 2 may have a direct teaching function. The operator grips a grip part arranged at the robot and directly changes the position and the orientation of the robot. The manual control unit 59 calculates a force applied to the grip part, based on the output of a force sensor arranged at the robot. The manual control unit 59 can change the position and the orientation of the robot based on the direction in which a force is applied and the magnitude of the force.

In this way, the operator 89 can change the position and the orientation of the robot by manual operation. In this example, the operator 89 adjusts the position and the orientation of the robot 1 so that the position of the origin of the tool coordinate system 92 is at a height corresponding to the neck of the operator 89. When the operator presses the button 81a of the image 81, the feature acquisition unit 58 acquires the position and the orientation of the robot 1 from the state detection unit 55. The feature acquisition unit 58 calculates the height as the physical feature of the operator based on the position and the orientation of the robot 1 when the robot 1 is manually driven. The feature acquisition unit 58 can calculate the height of the neck of the operator 89 based on the position of the robot 1 in the reference coordinate system 91 and a predetermined height from the floor surface to the origin of the reference coordinate system 91. The feature acquisition unit 58 can calculate the height of the operator 89 by adding a predetermined width of the head to the height of the neck.

Referring to FIG. 10, the display control unit 54 displays the height calculated by the feature acquisition unit 58 in the text box 81b of the image 81. The operator can check the height by looking at the text box 81b. When the operator presses the button 81c of the image 81, the height is set. The image 71 illustrated in FIG. 5 is displayed and the measured height is displayed in the text box 72a of the portion 72.

Alternatively, referring to FIG. 10, the button 81a may be a button for starting manual operation. The display control unit 54 may intermittently display the height corresponding to the manual operation of the robot apparatus 3. When the operator presses the button 81a, the manual control unit 59 starts the manual operation of the robot apparatus 3. The operator 89 changes the position and the orientation of the robot 1. The feature acquisition unit 58 calculates the height of the operator 89 based on the position and the orientation of the robot 1 at predetermined intervals. The display control unit 54 displays the height calculated by the feature acquisition unit 58 in the text box 81b of the image 81. When the position and the orientation of the robot 1 are at a desired position and a desired orientation, the manual operation of the robot apparatus 3 is stopped. The operator can set the height by pressing the button 81c of the image 81.

In the present embodiment, the robot is driven so that the tool center point is arranged at the height of the neck of the operator, but the present disclosure is not limited to this configuration. For example, the robot apparatus may be driven so that the flange center of the robot is at the height of the top of the head of the operator. The feature acquisition unit can calculate the height based on the part of the operator who aligns the position of the constituent member of the robot apparatus.

Subsequently, the feature acquisition unit 58 can acquire the physical feature of the operator based on the output of the sensor as further control for acquiring another height. Referring to FIGS. 2 and 7, the operator can set the height of the operator based on the image captured by the camera 6 by pressing the button 78c. The button 78c is a button for measuring the height of the operator by using the camera 6 as a sensor arranged at the robot apparatus 3.

Referring to FIGS. 1 and 2, the camera 6 is fixed at a position for capturing an image of the head of the operator 89. The position and the orientation of the camera 6 of the present embodiment are fixed. The feature acquisition unit 58 of the present embodiment is formed so as to be able to perform image processing. The operator 89 can arrange a scale indicating the height in the background of the head 89a. Subsequently, the camera 6 images the head 89a of the operator 89 and the scale indicating the height.

The feature acquisition unit 58 can detect the outline of the head by performing image processing. The outline of the head of the operator can be detected by, for example, a pattern matching method. Subsequently, the feature acquisition unit 58 can detect the height of the operator, based on the position of the top of the head of the operator and the image of the scale in the background of the head. Subsequently, the height is input to the text box 72a of the portion 72 of the image 71 illustrated in FIG. 5.

Alternatively, marks that can be detected by image processing can be prepared in advance. The mark is arranged at the height of the operator. Subsequently, an image of the mark and the scale indicating the height may be captured by the camera. This method does not need to detect the head of the operator. As the mark that can be detected by the image processing, for example, a QR code (registered trademark) can be exemplified.

Alternatively, the camera may be attached to the robot. For example, the camera can be fixed to the wrist of the robot. The position and the orientation of the robot may be manually changed corresponding to the height of the operator so that the head of the operator is imaged.

In the present embodiment, a camera that captures a two-dimensional image is arranged as a sensor for acquiring the physical features of the operator, but the present disclosure is not limited to this configuration. Any sensor capable of acquiring the physical feature of the operator can be employed. For example, as the sensor, a three-dimensional sensor such as a range sensor capable of acquiring three-dimensional position information, a light curtain capable of detecting the height of an object, or the like can be employed.

In the present embodiment, in addition to setting the height by manual input, the height can be acquired from a database, the height of a body part can be measured by manually driving the robot, or the height can be set by imaging the body part with a camera as a sensor, but the present disclosure is not limited to this configuration. The controller may be configured to be able to set the physical feature by at least one method. For example, in the present embodiment, the camera may not be provided. When the operator manually inputs the height, the camera and the feature acquisition unit may not be provided.

Although there is one model of the robot apparatus for determining whether or not the predetermined portion of the robot apparatus of the present embodiment has entered the specific region, the present disclosure is not limited to this configuration. The models of the robot and the work tool can be formed to be changeable.

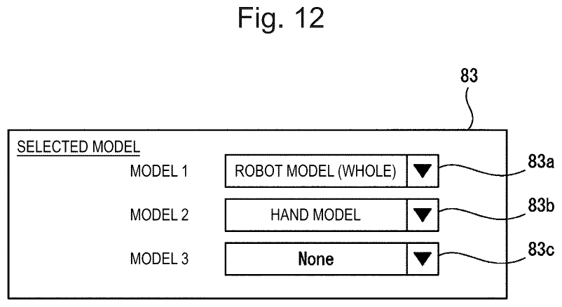

FIG. 12 illustrates an image for selecting the model of the robot apparatus in the present embodiment. An image 83 is an image for setting a three-dimensional model for determining whether or not a predetermined portion of the robot apparatus 3 has entered the specific region during a period in which the robot 1 is driven. The image 83 can be added to the image 71 of FIG. 5, for example. Alternatively, the image 71 can include a button for selecting a three-dimensional model. The image 83 may be displayed as a pop-up image when the operator presses the button.

The operator who works cooperatively with the robot apparatus can generate a plurality of types of three-dimensional models in advance. For example, a robot model including all constituent members of the robot, a robot model formed by some constituent members of the robot such as the upper arm and the lower arm of the robot, a work tool model, and the like can be prepared in advance. The operator can store these models in the storage 42 in advance.

In list boxes 83a to 83c of the image 83, the operator who works cooperatively with the robot apparatus can select a three-dimensional model to be used for determination of entry into the specific region. In the present embodiment, a plurality of three-dimensional models can be selected. In the example illustrated in FIG. 12, a model of the robot formed by all the constituent members of the robot is selected in the list box 83a. A model of a hand is selected in the list box 83b. The model generation unit 53 of the processing unit 51 generates a three-dimensional model in which the model of the robot and the model of the hand are combined. The operation determination unit 56 can determine whether or not at least one selected from a group of the model of the robot and the model of the hand enters the specific region.

In addition, by switching the model of the robot apparatus, the predetermined portion of the robot apparatus for determining entry into the specific region can be changed. For example, when the model of the robot including only models of the upper arm and the lower arm of the robot is employed, the operation determination unit can determine whether or not at least one selected from a group of the upper arm and the lower arm of the robot has entered the specific region. For example, when no work tool is included in the three-dimensional model, determination regarding whether or not the work tool has entered the specific region can be set not to be performed.

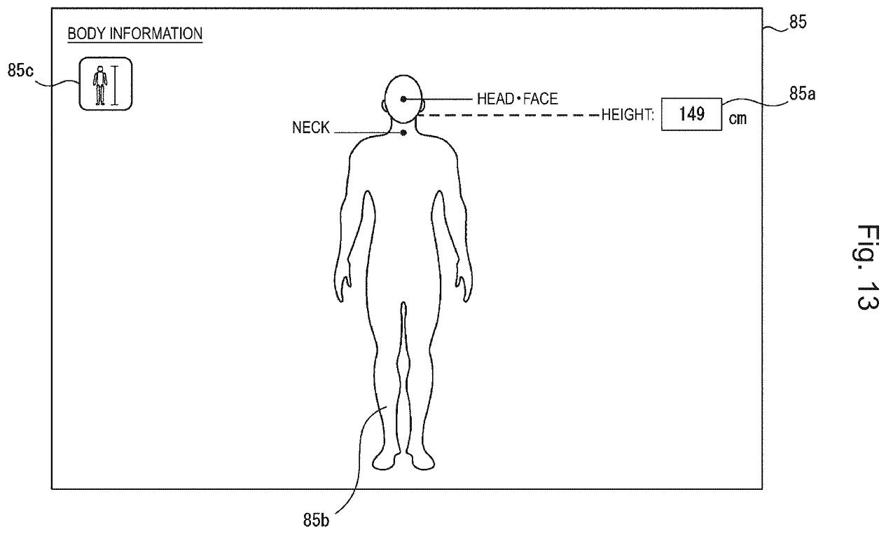

The above-described embodiment is not limited to the image 71 of FIG. 5. As an alternative example, FIG. 13 illustrates another image for setting a body part displayed on the display part.

An image 85 illustrated in FIG. 13 is an image displayed instead of the image 71 of FIG. 5. The image 85 is formed so that a height can be set in a text box 85a for the body part indicated by an image 85b of a person. Based on the height set in the text box 85a, the height of the operator is calculated. Also in the image 85, by pressing a button 85c, the height of the body can be set from the database, set by the position and orientation of the robot apparatus, or set by the image of the camera. The operator sets the height and the body region by using the image 85. The work region setting unit automatically sets a work region. For example, the entire movable range of the robot 1 or a predetermined region is set as the work region. The region setting unit sets a common part of the body region and the work region as a specific region.

In the above-described embodiment, the operation determination unit determines whether or not at least a part of the robot apparatus has entered the specific region, but the present disclosure is not limited to this configuration. The operation determination unit may determine that at least a part of the robot apparatus is likely to enter the specific region. For example, after a sensor that detects entry into a preliminary region around the specific region is arranged, when a part of the robot apparatus enters the preliminary region, it may be determined that there is a possibility that the robot apparatus enters the specific region.

### Second Embodiment

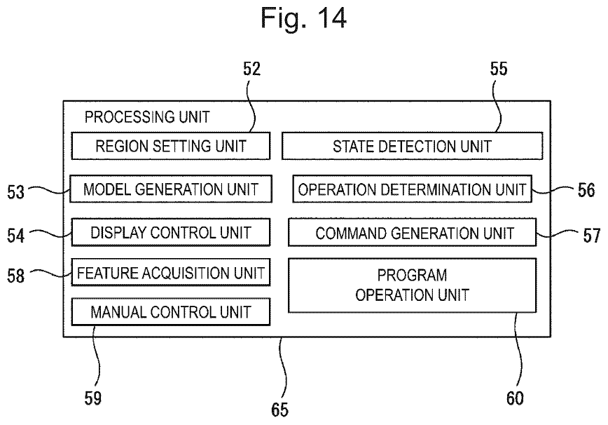

A robot controller in a second embodiment is described with reference to FIGS. 14 to 18. The configuration of a robot 1 of the present embodiment is similar to the configuration of the robot 1 of the first embodiment (see FIG. 1). The robot controller of the present embodiment performs a simulation before a robot apparatus actually performs work. When there is a possibility of contact between the robot apparatus and an operator who performs cooperative work, an operation program for driving the robot is corrected.

FIG. 14 illustrates a block diagram of a processing unit of the robot controller of the present embodiment. A processing unit 65 included in a controller body of the robot controller of the present embodiment includes a program operation unit 60 that verifies the operation program 69 or corrects the operation program 69. The other configurations of the processing unit 65 are similar to the configurations of the processing unit 51 in the first embodiment (see FIG. 2). Each of the processing unit 65 and the program operation unit 60 corresponds to a processor that is driven in accordance with a predetermined program. By reading the program and performing control defined in the program, the processor serves as each of the units.

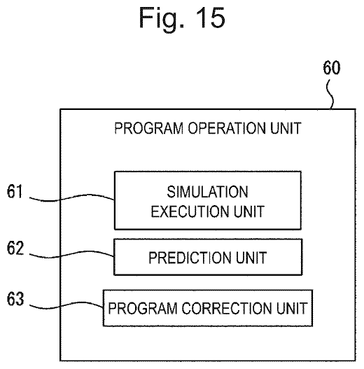

FIG. 15 illustrates a block diagram of the program operation unit of the present embodiment. Referring to FIGS. 14 and 15, the program operation unit 60 performs a simulation of the robot apparatus 3 based on the operation program 69 and the three-dimensional model of the robot apparatus, or automatically corrects the operation program 69.

The program operation unit 60 includes a simulation execution unit 61 that performs a simulation of the operation of the robot apparatus 3 based on a predetermined operation program 69 of the robot apparatus 3. The simulation execution unit 61 performs a simulation of the robot apparatus 3 by changing the position and the orientation of the three-dimensional model generated by the model generation unit 53, based on the operation program 69. For example, the simulation execution unit 61 acquires the position and the orientation of the robot 1 at the teaching point defined in the operation program 69, and calculates the position and the orientation of each constituent member of the robot apparatus 3. The simulation execution unit 61 acquires the models of the constituent members of the robot apparatus 3 from the model generation unit 53, and arranges the model of the robot apparatus in a three-dimensional virtual space based on the position and the orientation of each constituent member. The simulation execution unit 61 also sets the model of the specific region SR in the three-dimensional virtual space based on the height of the operator and the work region.

The processing unit 51 includes a prediction unit 62 that predicts whether or not a predetermined portion of the robot enters the specific region when the robot is driven based on the operation program 69. The prediction device 62 can predict that the robot apparatus 3 will move to a position and an orientation without actually driving to the position. For example, the prediction unit 62 determines whether or not a predetermined portion of the robot apparatus 3 enters the specific region SR during a period in which a simulation is performed.

The program operation unit 60 includes a program correction unit 63 that corrects the operation program 69 so that the predetermined portion of the robot apparatus 3 does not enter the specific region when the robot 1 is driven based on the operation program 69. The program correction unit 63 corrects the operation program 69 based on a result of the simulation. Each of the simulation execution unit 61, the prediction unit 62, and the program correction unit 63 corresponds to a processor that is driven in accordance with the operation program 69.

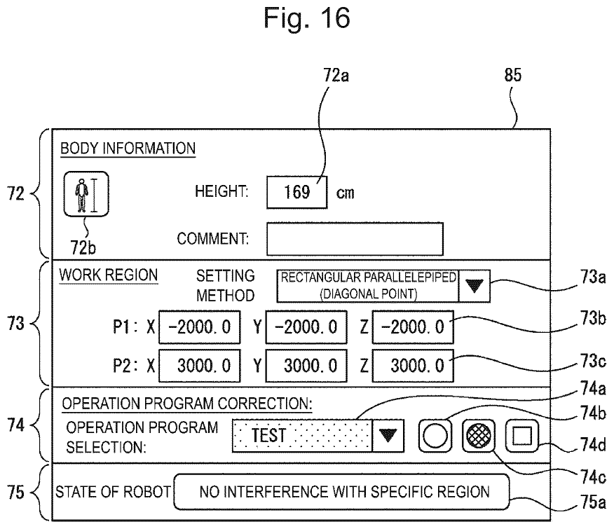

FIG. 16 illustrates an image displayed on the display part of the teach pendant in the present embodiment. In an image 85, portions 74 and 75 are added to the image 71 (see FIG. 5) of the first embodiment. The portion 74 of the image 85 is a portion to be operated when the simulation of the robot apparatus 3 is performed or the operation program 69 is corrected. The portion 75 of the image 85 is a portion for displaying the result of the simulation of the robot apparatus. In the image 85 of the present embodiment, by operating the portion 74, the simulation of the robot apparatus 3 can be performed or the operation program 69 can be corrected.

The operator who prepares the operation program 69 determines a reference height of the operator when preparing the operation program 69. For example, the height of the operator who prepares the operation program 69 is set as the reference height. The operator prepares an operation program so that at least a part of the robot apparatus does not enter a region where the head of the operator having the reference height is present. Alternatively, the operator may prepare the operation program 69 so that the tool center point does not enter into the region where the head of the operator having the reference height is present.

The operator who prepares the operation program inputs the reference height to the text box 72a of the portion 72. The operator can select an operation program for actually performing work from a list box 74a. In this case, an operation program named “TEST” is selected. When the operator who prepares the operation program presses a button 74d in the portion 74, the program operation unit 60 stores the reference height set in the portion 72 in the storage 42 in association with the program displayed in the portion 74.

Subsequently, the operator who works cooperatively with the robot apparatus performs a simulation and corrects the result of the simulation and the operation program as necessary. The operator who performs the cooperative work sets, in the portion 72, the height of the operator who performs the cooperative work. The operator also sets the work region in the portion 73.

The operator who performs the cooperative work selects an operation program for actually performing work from a list box 74a of the portion 74. In this case, the operation program named “TEST” is selected. When the operator presses a button 74b, the simulation execution unit 61 performs a simulation of the robot apparatus 3 based on the operation program TEST.

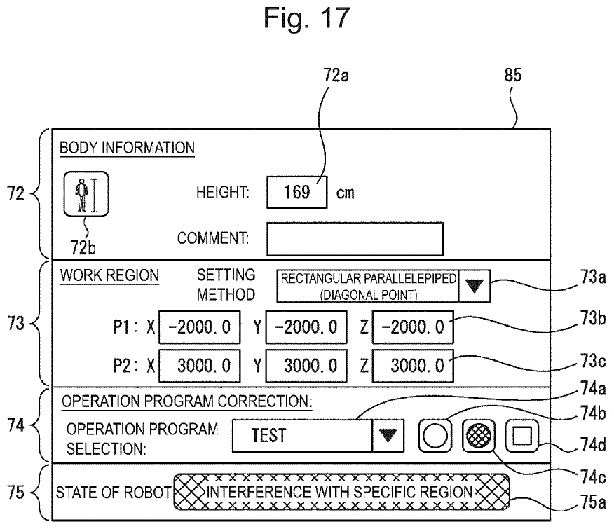

FIG. 17 illustrates a main image when it is determined that a part of the robot apparatus enters the specific region. When the prediction unit 62 determines that the predetermined portion of the robot apparatus 3 enters the specific region SR, the display part 28 displays a warning indicating that the predetermined portion of the robot apparatus 3 enters the specific region SR. More specifically, in the present embodiment, when it is determined that at least a part of the robot apparatus 3 enters the specific region SR, the display part 28 displays, in a notification box 75a of the portion 75, a possibility that the robot apparatus 3 enters the specific region SR. Moreover, the display control unit 54 can change the notification box 75a for the state of the robot to red or the like. By this warning, the operator can know that the robot apparatus 3 may enter the specific region. The operator who performs the cooperative work can manually correct the operation program, for example.

In the above-described embodiment, the prediction unit 62 determines whether or not at least a part of the robot apparatus has entered the specific region based on the result of the simulation of the robot apparatus 3, but the present disclosure is not limited to this configuration. The prediction unit may extract teaching points set in the operation program and determine whether or not the positions of the teaching points are arranged inside the specific region. When the position of at least one teaching point is arranged inside the specific region, the prediction unit can predict that at least a part of the robot apparatus enters the specific region. Alternatively, for example, the prediction unit may determine whether at least a part of the robot apparatus 3 is likely to enter the specific region during a period in which the robot apparatus 3 is driven. When the robot apparatus 3 is likely to enter, control for stopping the robot apparatus 3 is performed before the robot apparatus 3 enters, and the operator can know a teaching point to be corrected by checking the operation program.

Subsequently, the controller 2 of the present embodiment can automatically correct the operation program so that a predetermined portion of the robot apparatus 3 does not enter the specific region. Referring to FIGS. 15 and 17, when the operator performing the cooperative work presses a button 74c, the program correction unit 63 performs control for correcting the operation program TEST.

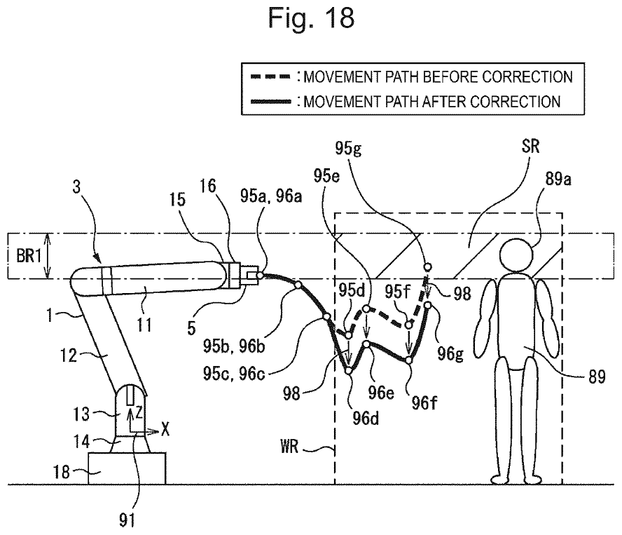

FIG. 18 illustrates a schematic side view of the robot apparatus for explaining a method of correcting the operation program. FIG. 18 illustrates a movement path of the robot apparatus 3 based on the operation program before correction and a movement path of the robot apparatus 3 based on the operation program after correction. In the operation program before correction, teaching points 95a to 95g are determined. In addition, teaching points 96a to 96g are set in the operation program after correction.

The operation program 69 is prepared so that at least a part of the robot apparatus does not enter the specific region where the head of the operator having the reference height is present. However, when the height of an operator who actually performs cooperative work is different from the reference height, the teaching point may be arranged inside the region where the head of the operator who performs the cooperative work is present.

With reference to FIGS. 15 and 18, the prediction unit 62 determines whether or not the teaching points 95a to 95g are arranged inside the specific region SR. When at least one of the teaching points 95a to 95g is arranged inside the specific region SR, the program correction unit 63 performs control for correcting the operation program by changing the position of the teaching point.

In the present embodiment, the program correction unit 63 sets the teaching points 96a to 96c without changing the positions of the teaching points 95a to 95c arranged outside the work region WR. The program correction unit 63 changes the positions of teaching points 95d to 95g before correction arranged inside the work region WR. As indicated by an arrow 98, the program correction unit 63 performs control for lowering the positions of the teaching points 95d to 95g and sets the teaching points subjected to the control as teaching points 96d to 96g after correction.

When the teaching points 95d to 95g are present inside the specific region SR, the program correction unit 63 calculates the difference between the reference height and the height of the operator who performs the cooperative work. Subsequently, based on this difference, the program correction unit 63 moves the teaching points 95d to 95g before correction in a direction away from the specific region SR and sets the teaching points 96d to 96g after correction. In other words, the amount of movement of the teaching point indicated by the arrow 98 corresponds to the difference between the reference height described in the operation program and the height of the operator who performs the cooperative work. In this example, control for moving the teaching point in the direction of the Z axis of the reference coordinate system 91 is performed. The program correction unit 63 corrects the positions of the teaching points 95d to 95g to the positions of the teaching points 96d to 96g in the operation program.

In this way, by performing the control for automatically correcting the operation program, the teaching point being arranged inside the specific region SR can be avoided. In other words, the robot apparatus 3 can be suppressed from entering the specific region SR.

In the above-described embodiment, the teaching point is moved by a movement amount corresponding to the height difference so that the teaching point defined in the operation program is not arranged inside the specific region SR, but the present disclosure is not limited to this configuration. The amount of movement of the teaching point may be calculated by performing a simulation by using the three-dimensional model of the robot. The amount of movement of the teaching point by which the entire robot apparatus does not enter the specific region may be calculated, and the position of the teaching point may be corrected by the amount of movement. The corrected operation program can be stored in the storage 42 together with the name and height of the operator.

In the above-described embodiment, the program correction unit changes the position of the teaching point arranged inside the work region, but the present disclosure is not limited to this configuration. The position of a teaching point at which at least a part of the robot apparatus enters the specific region may be detected, and the position of the teaching point may also be changed.

Since other configurations, operations, and effects are similar to those of the robot controller in the first embodiment, descriptions thereof are not repeated here.

### Third Embodiment

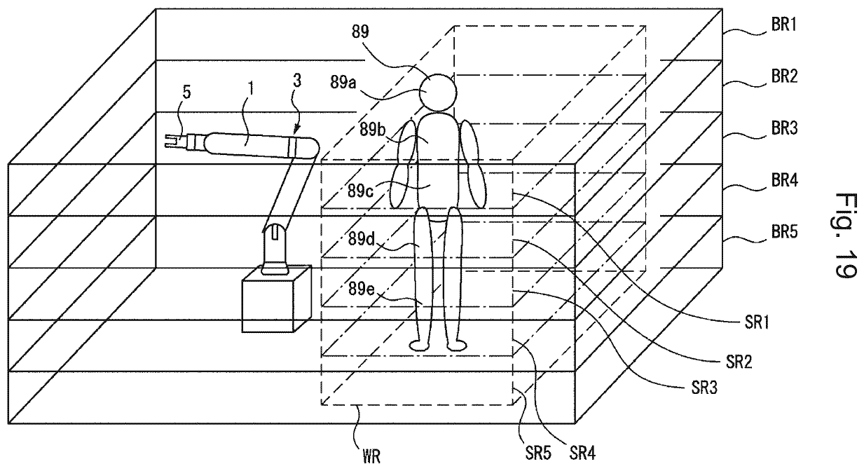

A robot controller in the third embodiment is described with reference to FIGS. 19 to 22. In the first embodiment, the height is taken as an example of the physical feature of the operator. In the present embodiment, the height of an arbitrary part of the body of the operator is employed as the physical feature of the operator. The configuration of the robot controller in the present embodiment is similar to the configuration of the controller of the robot apparatus in the first embodiment and the second embodiment (see FIGS. 1, 2, 3, 14, and 15).

FIG. 19 illustrates a schematic perspective view for explaining a work region, a body region, and a specific region of the present embodiment. In this example, in addition to the head 89a of the operator 89, a chest 89b, an abdomen 89c, an upper leg 89d being an upper part of a foot, and a lower leg 89e being a lower part of the foot are defined. The body region setting unit 52a sets body regions BR1 to BR5 extending horizontally according to the respective parts. The body region setting unit 52a can set the body regions BR1 to BR5 with predetermined widths based on the heights of the respective body parts. For example, each body region can be set with a width of 20 cm or more and 30 cm or less in the height direction. In the present embodiment, each of the body regions BR1 to BR5 is set within a range reached by the robot apparatus 3 including the robot 1 and the work tool 5.

It should be noted that the body region of each part may be a region partitioned by a boundary surface extending in the vertical direction. In particular, three or more body regions may be set for the body of the operator. For example, the body region may be vertically divided into three regions, i.e., a body region of the main body of the body including the chest of the operator, a body region of the right hand, and a body region of the left hand.

The work region setting unit 52b sets a work region WR being a region where the operator 89 works. Subsequently, the region setting unit 52 sets overlapping portions of the respective body regions BR1 to BR5 and the work region WR as specific regions SR1 to SR5 for the respective parts of the body. For example, the specific region SR5 is a region corresponding to a region under the knees of the operator. In this example, five specific regions SR1 to SR5 are set.

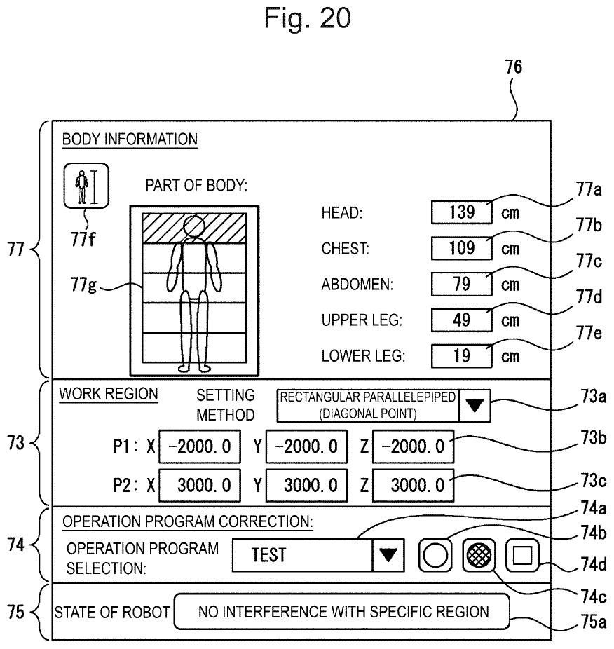

FIG. 20 illustrates a main image displayed on the display part of the teach pendant in the present embodiment. An image 76 is a main image for controlling the operation of the robot apparatus. The image 76 includes a portion 77 for setting heights of a plurality of feature portions of the operator. The portion 73 operated when setting the work region, the portion 74 operated when performing the simulation of the robot apparatus, and the portion 75 displaying the warning of the operation of the robot apparatus are similar to the images 71 and 85 being the main images of the controller of the first embodiment and the second embodiment (see FIGS. 5 and 16). It should be noted that the images 71 and 85 may not be displayed.

In the portion 77 of the image 76, an image 77g indicating a body region of a head, a body region of a chest, a body region of an abdomen, a body region of upper legs, and a body region of lower legs of the operator is displayed. Each portion of the image 77g can be selected by the operator who operates the teach pendant 26.

In the portion 77 of the image 76, text boxes 77a to 77e are displayed as input regions for inputting the heights of respective parts of the operator. In the text boxes 77a to 77e, the height of the upper surface of each body region or the height of the lower surface of each body region can be input.

In the text boxes 77a to 77e, the height of each part can be input by a method in the similar manner as in the text box 72a (see FIG. 5) of the height of the controller in the first embodiment. As a basic input method, the operator performing the cooperative work can directly input the height to the text boxes 77a to 77e.

In addition, similarly to the image of the controller of the first embodiment, the height of the body part can be selected from the database, the height of the body part can be set by manually driving the robot, or the height can be set by imaging each part with a camera as a sensor.

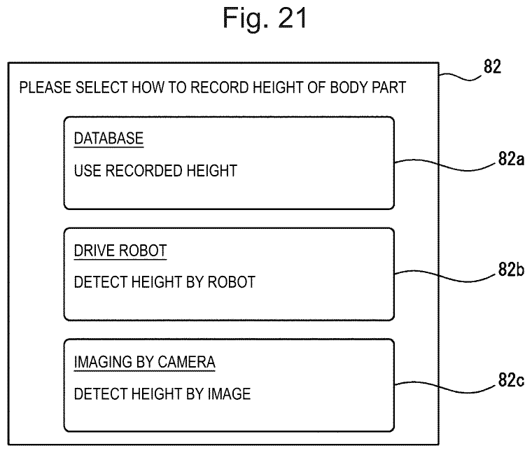

FIG. 21 illustrates an image for setting the height of each part. Referring to FIGS. 20 and 21, when the operator selects a desired portion from an image 77g and presses a button 77f, an image 82 is displayed. In the image 82, as in the image 78 (see FIG. 7) of the first embodiment, a button 82a for operating the database of the height of each part, a button 82b for setting the height of the part by manually driving the robot, and a button 82c for setting the height of the part by the image captured by the camera are displayed.

The operator can set the height of each part by operating each of the buttons 82a to 82c by the operation method similar to that in the first embodiment. For example, when the operator selects the abdomen from the image 77g of FIG. 20 and presses the button 77f, the display control unit 54 displays the image 82 illustrated in FIG. 21. Subsequently, the height of the abdomen can be set by operating the database using the button 82a, manually operating the robot using the button 82b, or capturing an image using the button 82c. The operator can perform this operation for each part.

The robot controller of the present embodiment can control the operation of the robot apparatus based on each part. For example, the operation determination unit 56 can determine whether or not a predetermined portion of the robot apparatus 3 has entered the specific regions SR1 to SR5. In the present embodiment, the operation determination unit 56 determines whether or not at least a part of the robot apparatus 3 has entered at least one of the specific regions SR1 to SR5. When the robot apparatus 3 has entered at least one of the specific regions SR1 to SR5, the command generation unit 57 can perform control for stopping the robot apparatus 3.

Alternatively, some specific regions may be selected from a plurality of specific regions in order to determine the entry of the robot apparatus 3. For example, only the specific region SR1 of the head and the specific region SR2 of the chest may be selected. In this case, when a predetermined portion of the robot apparatus 3 has entered at least one selected from a group of the specific region SR1 and the specific region SR2, the control for stopping the robot apparatus 3 can be performed.

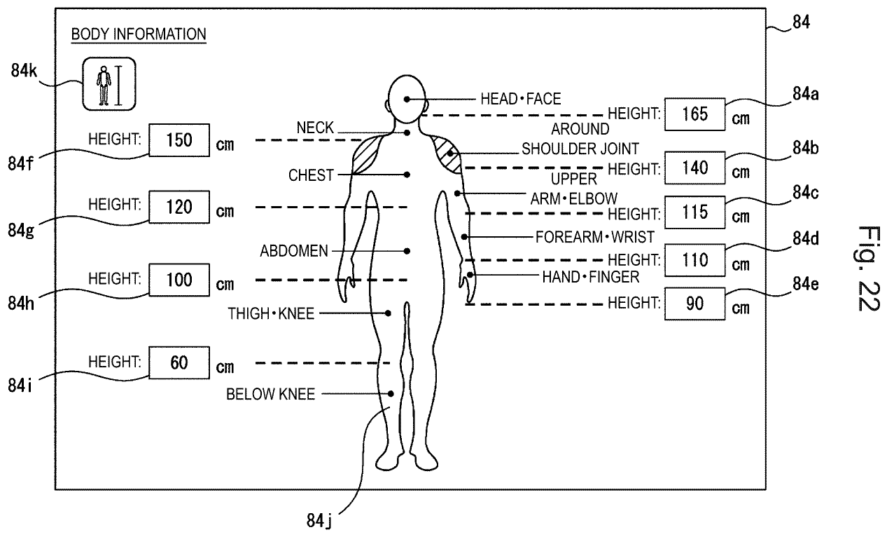

The present embodiment is not limited to the image 76 in FIG. 20. As an alternative example, FIG. 22 illustrates another image showing a body part displayed on the display part. An image 84 illustrated in FIG. 22 is an image displayed instead of the image 76 of FIG. 20. In the image 84, a body part is finely divided into a peripheral part of a shoulder joint, an upper arm, and the like. The height can be set in the text boxes 84a to 84i for the body region of each body part. In addition, a desired part can be selected in an image 84j of a person. In this case, the periphery of the shoulder joint is selected. Also in the image 84, by pressing a button 84k, the height of each part can be set from the database, set by the position and the orientation of the robot apparatus, or set by the image of the camera. The operator sets a body region by using the image 84. The work region setting unit automatically sets a work region. For example, the entire movable range of the robot 1 or a predetermined region is set as the work region. The region setting unit sets a common part of the body region and the work region as a specific region.

In the present embodiment, the program correction unit 63 may correct the operation program so that the teaching point is located in the outermost region of a selected specific region SR where no problem occurs even when the robot apparatus 3 moves.

Since other configurations, operations, and effects of the robot controller are similar to those of the robot controller in the first embodiment and in the second embodiment, descriptions thereof are not repeated here.

### Fourth Embodiment

A robot controller in the fourth embodiment is described with reference to FIGS. 19 and 20. In the present embodiment, a plurality of body parts are set as in the third embodiment. In the present embodiment, control for driving the robot at a speed limit of the robot determined in accordance with the body part is performed.

Referring to FIGS. 19 and 20, a speed limit for driving the robot can be set for each region of each part. For example, when the driving speed of the robot is low, it can be determined that the robot apparatus may come into contact with the operator. In this case, the speed limit of the robot can be determined corresponding to the specific region of the body part. As the speed of the robot, a speed of a predetermined portion of the robot can be employed. For example, the movement speed of the tool center point of the robot apparatus can be employed.

The state detection unit 55 can calculate the movement speed of the tool center point, based on the position and the orientation of the robot 1 acquired at predetermined time intervals. When at least a part of the robot apparatus enters the specific region of each part, the operation determination unit 56 determines whether or not the movement speed of the tool center point exceeds the speed limit determined corresponding to each part. When the movement speed of the tool center point exceeds the speed limit of at least one part, the command generation unit 57 can perform control for stopping the robot apparatus.

For example, when the robot apparatus 3 enters the region of the upper leg, the operation determination unit 56 acquires the speed limit corresponding to the upper leg. The operation determination unit 56 determines whether or not the movement speed of the tool center point exceeds the speed limit corresponding to the upper leg. When the movement speed of the tool center point exceeds the speed limit corresponding to the upper leg, the command generation unit 57 can stop the robot apparatus.

In the present embodiment, when the movement speed of the robot apparatus exceeds the speed limit determined based on the physical feature, control for stopping the robot apparatus can be performed. This control can reduce conditions under which the robot apparatus stops, thereby suppressing the robot apparatus from stopping. As a result, the work efficiency of the robot apparatus is improved.

In the present embodiment, the speed of the tool center point is employed as the speed of the robot, but the present disclosure is not limited this configuration. When a three-dimensional model of the robot is used, the speed of any part of the robot can be calculated by the three-dimensional model. For example, a maximum speed at a given point of a constituent member of the robot, which is arranged inside the specific region of each part, can be calculated. When the speed of the robot exceeds the speed limit, control for stopping the robot can be performed.

The processing unit of the controller may perform control for stopping the robot apparatus when the predetermined portion of the robot apparatus has entered the specific region or control for stopping the robot apparatus when the predetermined portion of the robot apparatus has entered the specific region and the movement speed of the robot apparatus exceeds the speed limit determined based on the physical feature. When the controller is formed to be able to perform both of these controls, for example, an image for selecting one of the controls can be displayed in the image 76 illustrated in FIG. 20. Alternatively, an image for selecting one of the controls can be displayed for each part. The processing unit can perform control selected by an operator's operation.

Since other configurations, operations, and effects are similar to those of the robot controller in the first embodiment to the third embodiment, descriptions thereof are not repeated here.

The robot controller of at least one of the above-described embodiments can set a region where the operation of the robot is limited based on the individual physical features of the operator who actually performs work.

The present disclosure has been described in detail thus far, but the present disclosure is not limited to the individual embodiments described above. Various additions, replacements, changes, partial deletions, and the like can be made to these embodiments without departing from the gist of the present disclosure or without departing from the gist of the present disclosure derived from the contents described in the claims and equivalents thereof. Further, these embodiments can also be combined and implemented. For example, in the above-described embodiments, the order of the operations and the order of the processes are given as examples, and are not limited thereto. The same applies to a case where a numerical value or a mathematical expression is used in the description of the above-described embodiments.

The following supplementary notes are disclosed with regard to the above-described embodiments and modified examples.

### Supplementary Note 1

A robot controller 2 including:
an operation control unit 43 configured to control an operation of a robot 1;
a storage 42 configured to store a physical feature of an operator 89; and
a region setting unit 52 configured to set specific regions SR and SR1 to SR5 where the operation of the robot is limited based on the physical feature.

### Supplementary Note 2

The robot controller of supplementary note 1, further including an operation determination unit 56 configured to determine whether or not a predetermined portion of at least one selected from a group of the robot, a work tool attached to the robot, and a workpiece has entered the specific region during a period in which the robot is driven, wherein
the operation control unit stops the robot when the predetermined portion has entered the specific region.

### Supplementary Note 3

The robot controller of supplementary note 1 or 2, wherein the physical feature includes a height of a part of a body of the operator.

### Supplementary Note 4

The robot controller according to any one of supplementary notes 1 to 3, wherein the physical feature is a height BH of the operator.

### Supplementary Note 5

The robot controller according to any one of supplementary notes 1 to 4, wherein the region setting unit sets the specific region extending in a horizontal direction.

### Supplementary Note 6

The robot controller according to any one of supplementary notes 1 to 5, further including an operation determination unit 56 configured to determine whether or not a predetermined portion of at least one selected from a group of the robot and a work tool attached to the robot has entered the specific region during a period in which the robot is driven, wherein
when the predetermined portion has entered the specific region, the operation determination unit determines whether or not a speed of the robot has exceeded a speed limit determined based on the physical feature, and
the operation control unit stops the robot when the speed has exceeded the speed limit.

### Supplementary Note 7

The robot controller according to any one of supplementary notes 1 to 6, further including:
a prediction unit 62 configured to predict whether or not a predetermined portion of the robot enters the specific region; and
a program correction unit 63 configured to correct, when the robot is driven based on an operation program of the robot, the operation program so that the predetermined portion of the robot does not enter the specific region.

### Supplementary Note 8

The robot controller according to any one of supplementary notes 1 to 6, further including:
a prediction unit 62 configured to predict whether or not a predetermined portion of the robot enters the specific region; and
a display part 28 configured to display that the predetermined portion of the robot enters the specific region when the prediction unit determines that the predetermined portion of the robot enters the specific region.

### Supplementary Note 9

The robot controller according to any one of supplementary notes 1 to 6, further including a prediction unit 62 configured to predict whether or not a predetermined portion of the robot enters the specific region, wherein
the robot is stopped when the prediction unit 62 determines that the predetermined portion of the robot enters the specific region.

### Supplementary Note 10

The robot controller according to any one of supplementary notes 1 to 9, further including:
a display part 28 configured to display the physical feature of an operator; and
an input part 27 configured to operate information to be displayed on the display part, wherein
the storage stores the physical feature input by an operation of the input part by the operator.

### Supplementary Note 11

The robot controller according to any one of supplementary notes 1 to 9, further including:
a sensor configured to acquire the physical feature of an operator; and
a feature acquisition unit 58 configured to acquire the physical feature, wherein
the feature acquisition unit acquires the physical feature based on output of the sensor.

### Supplementary Note 12

The robot controller according to any one of supplementary notes 1 to 11, further including a feature acquisition unit 58 configured to acquire the physical feature of an operator, wherein
the feature acquisition unit acquires the physical feature based on at least one selected from a group of a position and an orientation of a robot when the robot is driven.

### Supplementary Note 13

The robot controller according to any one of supplementary notes 1 to 12, wherein the region setting unit sets a work region WR where the operator performs work in response to an operation of the operator, and sets, as the specific region, a region where body regions BR1 to BR5 corresponding to the physical feature and the work region overlap with each other.

### REFERENCE SIGNS LIST

1 Robot
2 Controller
3 Robot apparatus
5 Work tool
6 Camera
23 Position detector
26 Teach pendant
27 Input part
28 Display part
42 Storage
43 Operation control unit
51 Processing unit
52 Region setting unit
55 State detection unit
56 Operation determination unit
57 Command generation unit
58 Feature acquisition unit
59 Manual control unit
60 Program operation unit
62 Prediction unit
63 Program correction unit
69 Operation program
89 Operator
BR1 to BR5 Body region
WR Work region
SR, SR1 to SR5 Specific region
BH Height

1. A robot controller comprising:
an operation control unit configured to control an operation of a robot;
a storage configured to store a physical feature of an operator; and
a region setting unit configured to set a specific region where the operation of the robot is limited based on the physical feature.

2. The robot controller of claim 1, further comprising an operation determination unit configured to determine whether or not a predetermined portion of at least one selected from a group of the robot, a work tool attached to the robot, and a workpiece has entered the specific region during a period in which the robot is driven, wherein
the operation control unit is configured to stop the robot when the predetermined portion has entered the specific region.

3. The robot controller of claim 1, wherein the physical feature includes a height of a part of a body of the operator.

4. The robot controller of claim 1, wherein the physical feature is a height of the operator.

5. The robot controller of claim 1, wherein the region setting unit is configured to set the specific region extending in a horizontal direction.

6. The robot controller of claim 1, further comprising an operation determination unit configured to determine whether or not a predetermined portion of at least one selected from a group of the robot and a work tool attached to the robot has entered the specific region during a period in which the robot is driven, wherein
when the predetermined portion has entered the specific region, the operation determination unit is configured to determine whether or not a speed of the robot has exceeded a speed limit determined based on the physical feature, and
the operation control unit is configured to stop the robot when the speed has exceeded the speed limit.

7. The robot controller of claim 1, further comprising:
a prediction unit configured to predict whether or not a predetermined portion of the robot enters the specific region; and
a program correction unit configured to correct, when the robot is driven based on an operation program of the robot, the operation program so that the predetermined portion of the robot does not enter the specific region.

8. The robot controller of claim 1, further comprising:
a prediction unit configured to predict whether or not a predetermined portion of the robot enters the specific region; and
a display part configured to display that the predetermined portion of the robot enters the specific region when the prediction unit determines that the predetermined portion of the robot enters the specific region.

9. The robot controller of claim 1, further comprising a prediction unit configured to predict whether or not a predetermined portion of the robot enters the specific region, wherein
the robot is stopped when the prediction unit determines that the predetermined portion of the robot enters the specific region.

10. The robot controller of claim 1, further comprising:
a display part configured to display the physical feature of an operator; and
an input part configured to operate information to be displayed on the display part, wherein
the storage stores the physical feature input by an operation of the input part by the operator.

11. The robot controller of claim 1, further comprising:
a sensor configured to acquire the physical feature of an operator; and
a feature acquisition unit configured to acquire the physical feature, wherein
the feature acquisition unit is configured to acquire the physical feature based on output of the sensor.

12. The robot controller of claim 1, further comprising a feature acquisition unit configured to acquire the physical feature of an operator, wherein
the feature acquisition unit is configured to acquire the physical feature based on at least one selected from a group of a position and an orientation of a robot when the robot is driven.

13. The robot controller of claim 1, wherein the region setting unit is configured to set a work region where an operator performs work in response to an operation of the operator and set, as the specific region, a region where a body region corresponding to the physical feature and the work region overlap with each other.
